(19) United States
(12) Patent Application Publication
(10) Pub. No.: US 2024/0070878 A1
(43) Pub. Date: Feb. 29, 2024

(54) ELECTRONIC DEVICE OBTAINING METADATA WHILE OBTAINING VIDEO AND METHOD THEREOF

(71) Applicant: SAMSUNG ELECTRONICS CO., LTD., Suwon-si (KR)

(72) Inventors: Taihoon KIM, Suwon-si (KR); Younghak Oh, Suwon-si (KR); Seungeun Lee, Suwon-si (KR)

(73) Assignee: SAMSUNG ELECTRONICS CO., LTD., Suwon-si (KR)

(21) Appl. No.: 18/211,030

(22) Filed: Jun. 16, 2023

Related U.S. Application Data
(63) Continuation of application No. PCT/KR23/07103, filed on May 24, 2023.

(30) Foreign Application Priority Data
Aug. 30, 2022 (KR) 10-2022-0109504
Oct. 12, 2022 (KR) 10-2022-0130982

(51) Int. Cl. G06T 7/215; G06F 3/0346; G06V 10/20

(52) U.S. Cl. CPC G06T 7/215; G06F 3/0346; G06V 10/255

(57) ABSTRACT

An electronic device includes: a first housing; a second housing; a first sensor; a second sensor; at least one camera provided on the first housing; and a processor configured to: identify an angle between the first housing and the second housing, in a state of obtaining a video by controlling the at least one camera; identify a magnitude of a rotational motion of the electronic device, in the state of obtaining the video; and obtain information for segmenting a portion of the video, which corresponds to a time interval in which at least one of the identified angle being changing by exceeding a designated range or the identified magnitude of the rotational motion being exceeding a designated magnitude.

### CROSS-REFERENCE TO RELATED APPLICATION(S)

This application is a continuation of PCT International Application No. PCT/KR2023/007103 which was filed on May 24, 2023, and claims priority to Korean Patent Application No. 10-2022-0109504, filed on Aug. 30, 2022, and claims priority to Korean Patent Application No. 10-2022-0130982, filed on Oct. 12, 2022, in the Korean Intellectual Property Office, the disclosure of which are incorporated by reference herein their entirety.

### BACKGROUND

### 1. Field

One or more embodiments relate to an electronic device obtaining metadata of a video obtained by the electronic device and a method thereof.

### 2. Description of Related Art

An electronic device may include at least one camera. The electronic device may obtain a video by controlling the at least one camera. The at least one camera of the electronic device may be mounted on a printed circuit board and may be manufactured in the form of a module.

### SUMMARY

According to an aspect of the disclosure, an electronic device may include: a first housing; a second housing; a first sensor; a second sensor; at least one camera provided on the first housing; and a processor configured to: identify an angle between the first housing and the second housing, in a state of obtaining a video by controlling the at least one camera; identify a magnitude of a rotational motion of the electronic device, in the state of obtaining the video; and obtain information for segmenting a portion of the video, which corresponds to a time interval in which at least one of the identified angle being changing by exceeding a designated range or the identified magnitude of the rotational motion being exceeding a designated magnitude.

According to another aspect of the disclosure, a method performed by an electronic device may include: identifying an angle between a first housing and a second housing, in a state of obtaining a video by controlling at least one camera provided on the first housing of the electronic device; identifying a magnitude of a rotational motion of the electronic device, in the state of obtaining the video; and obtaining information for segmenting a portion corresponding to a time interval of the video, in which at least one of the angle being changing by exceeding a designated range or the identified magnitude of the rotational motion being exceeding a designated magnitude.

According to another aspect of the disclosure, an electronic device may include: at least one sensor configured to identify a motion of the electronic device; at least one camera; and a processor configured to: identify, by using the at least one sensor, the motion of the electronic device, in a state of obtaining a video by controlling the at least one camera, based on a shooting input; identify a position of at least one subject of the video, based on the identified motion of the electronic device, which corresponds to one of designated motions for segmenting the video; and obtain first metadata comprising a time interval in which one of the designated motions is identified or the position of the at least one subject.

According to another aspect of the disclosure, an electronic device may comprise a first housing, a second housing, a hinge assembly which rotatably couples the second housing with respect to the first housing, to the first housing, a sensor for identifying an angle of the first housing, the hinge assembly, and the second housing, at least one camera disposed on a surface of the first housing, and a processor. The processor may identify the angle by using the sensor, in state of obtaining a video by controlling the at least one camera. The processor may identify magnitude of a rotational motion of the electronic device, by using the second sensor, in the state of obtaining the video. The processor may obtain information for segmenting a portion corresponding to a time interval in the video, based on identifying the time interval in which at least one of the angle changing by exceeding a designated range or the magnitude of the rotational motion exceeding designated magnitude is identified.

According to an embodiment, a method of the electronic device may comprise identifying the angle by using a sensor for identifying the angle of a first housing, a hinge assembly which rotatably couples a second housing with respect to the first housing, to the first housing, and the second housing, in a state of obtaining a video by controlling at least one camera disposed on a surface of the first housing of the electronic device, based on a shooting input. The method of electronic device may comprise identifying magnitude of a rotational motion of the electronic device, by using the second sensor, in the state of obtaining the video. The method of electronic device may comprise obtaining information for segmenting a portion corresponding to the time interval in the video, based on identifying the time interval in which at least one of the angle changing by exceeding a designated range or the magnitude of the rotational motion exceeding designated magnitude is identified.

According to an embodiment, the electronic device may comprise at least one sensor for identifying motion of the electronic device, at least one camera, and a processor. The processor may identify the motion of the electronic device by using the at least one sensor, in a state of obtaining a video by controlling the at least one camera, based on a shooing input. The processor may identify position of at least one subject included in the video, based on identifying the motion of the electronic device corresponding to one of designated motions for segmenting the video. The processor may obtain metadata including a time interval in which one of the designated motions is identified, or the position of the at least one subject.

According to an embodiment, the method of the electronic device may comprise identifying the motion of the electronic device by using at least one sensor for identifying the motion of the electronic device in a state of obtaining a video by controlling at least one camera, based on the shooting input. The method of the electronic device may comprise identifying position of at least one subject included in the video, based on identifying the motion of the electronic device corresponding to one of designated motions for segmenting the video. The method of the electronic device may comprise obtaining metadata including a time interval in which one of the designated motions is identified, or the position of the at least one subject.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a block diagram of an electronic device in a network environment according to an embodiment;

FIG. 2A illustrates an example of a front view and a rear view of an electronic device according to an embodiment;

FIG. 2B illustrates an example of a block diagram of an electronic device according to an embodiment;

FIG. 3 illustrates an example of a block diagram of an electronic device according to an embodiment;

FIG. 4 illustrates an example of a video obtained by identifying a motion of an electronic device according to an embodiment;

FIG. 5 illustrates an example of a video obtained by identifying a motion of an electronic device according to an embodiment;

FIG. 6 illustrates an example of a state of use of an electronic device for guiding editing of a video, according to an embodiment;

FIG. 7 illustrates an example of a flowchart for an operation of an electronic device, according to an embodiment;

FIG. 8 illustrates an example of a flowchart for an operation of an electronic device, according to an embodiment; and

FIG. 9 illustrates an example of a flowchart for an operation of an electronic device, according to an embodiment.

### DETAILED DESCRIPTION

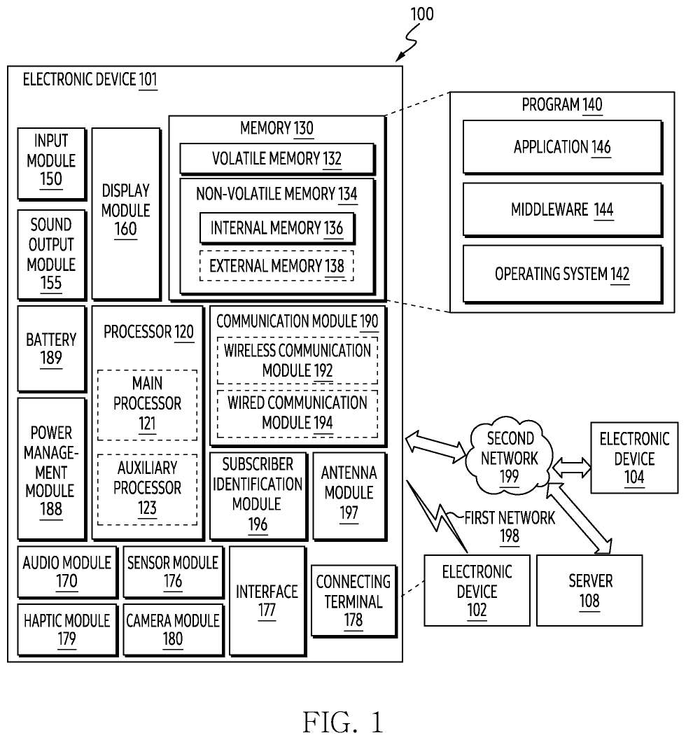

FIG. 1 is a block diagram illustrating an electronic device 101 in a network environment 100 according to one or more embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of lms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to one or more embodiments, the antenna module 197 may form an mmWave antenna module. According to an embodiment, the mmWave antenna module may include a printed circuit board, a RFIC provided on a first surface (e.g., the bottom surface) of the printed circuit board, or adjacent to the first surface and capable of supporting a designated high-frequency band (e.g., the mmWave band), and a plurality of antennas (e.g., array antennas) provided on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to one or more embodiments disclosed in the present document may be various types of devices. The electronic device may include, for example, a portable communication device (e.g., a smartphone), a computer device, a portable multimedia device, a portable medical device, a camera, a wearable device, or a home appliance. The electronic device according to an embodiment of the present document is not limited to the above-described devices.

The one or more embodiments and terms used herein are not intended to limit the technical features described herein to specific embodiments and should be understood to include various modifications, equivalents, or substitutes of the embodiment. With respect to the description of the drawings, similar reference numerals may be used for similar or related components. The singular form of the noun corresponding to the item may include one or more of the items unless clearly indicated differently in a related context. In this document, each of the phrases such as “A or B”, “at least one of A and B”, “at least one of A, B and C”, “at least one of A, B, or C”, and “at least one of A, B, or C” may include any one of the phrases together, or all possible combinations thereof. Terms such as “first”, “second”, or “second”, or “second” may be used simply to distinguish a corresponding component from another corresponding component, and are not limited to other aspects (e.g., importance or order). When some (e.g., the first) component is referred to as “coupled” or “connected” in another (e.g., the second) component, with or without the term “functional” or “communicatively”, it means that some of the components can be connected directly (e.g., wired), wirelessly, or through a third component.

The term “module” used in one or more embodiments of the present document may include a unit implemented in hardware, software, or firmware and be used interchangeably with terms such as logic, logic block, component, or circuitry, for example. The module may be a minimum unit or a part of the integrally configured component or the component that performs one or more functions. For example, according to an embodiment, the module may be implemented in the form of an application-specific integrated circuit (ASIC).

One or more embodiments of the present document may be implemented as software (e.g., a program) including one or more instructions stored in a storage medium (or external memory) readable by a device (e.g., electronic device 101). For example, a processor (e.g., a processor) of a device (e.g., electronic device 101) may call and execute at least one of the one or more instructions stored from a storage medium. This makes it possible for the device to operate to perform at least one function according to at least one command called. The one or more instructions may include code generated by a compiler or code that may be executed by an interpreter. The device-readable storage medium may be provided in the form of a non-transitory storage medium. Here, the term ‘non-transitory’ only means that a storage medium is a device that is tangible and does not include a signal (e.g., electromagnetic wave), and the term does not distinguish between a case where data is semi-permanently stored and a case where it is temporarily stored.

According to an embodiment, a method according to one or more embodiments disclosed in the present document may be provided by being included in a computer program product. The computer program products may be traded between sellers and buyers as products. The computer program products may be distributed in the form of device-readable storage media (e.g., compact disc read only memory (CD-ROM), or distributed (e.g., downloaded or uploaded) directly or online through an application store (e.g., Play Store™) or between two user devices (e.g., smartphones). In the case of online distribution, at least some of the computer program products may be temporarily stored or temporarily created on a device-readable storage medium such as a manufacturer's server, a server in an application store, or a memory in a relay server.

According to one or more embodiments, each of the above-described components (e.g., a module or a program) may include a single object or a plurality of objects, and some of the plurality of objects may be separated and provided in other components. According to one or more embodiments, one or more components or operations of the above-described corresponding components may be omitted, or one or more other components or operations may be added. Alternatively, or additionally, a plurality of components (e.g., modules or programs) may be integrated into one component. In this case, the integrated component may perform one or more functions of each of the components in the same or similar manner as those performed by the corresponding component among the plurality of components before the integration. According to one or more embodiments, operations performed by a module, a program, or other components may be executed sequentially, in parallel, repeatedly, or heuristic, performed in a different order, omitted, or one or more other operations may be added.

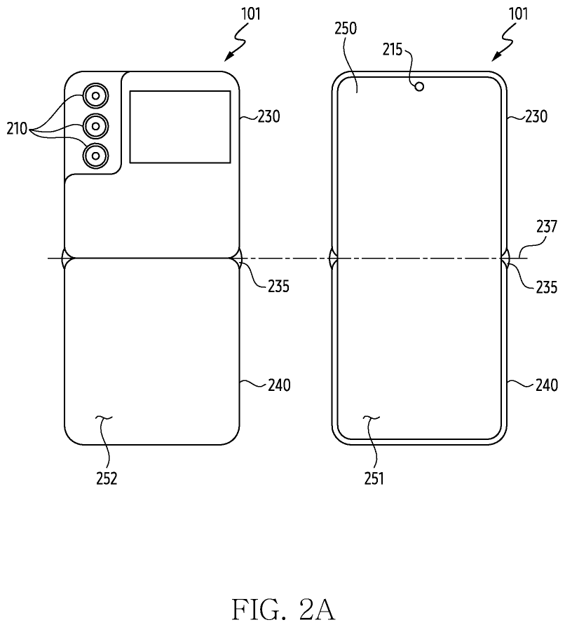

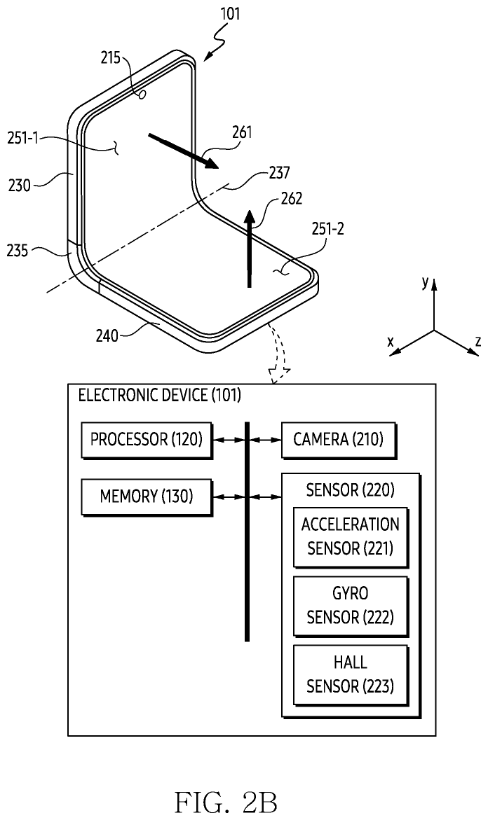

FIG. 2A illustrates an example of a front view and a rear view of an electronic device according to an embodiment. FIG. 2B illustrates an example of a block diagram of an electronic device according to an embodiment. An electronic device 101 of FIG. 2A may be an example of the electronic device 101 of FIG. 1.

Referring to FIG. 2A, the electronic device 101 according to an embodiment may provide an unfolding state in which a first housing 230 and a second housing 240 are fully folded out by a hinge assembly 235. For example, the unfolding state may include a state in which one surface of the first housing 230 including a display 250 corresponds to one surface of the second housing 240 including the display 250.

According to an embodiment, the electronic device 101 may include a camera 215 provided on one surface 251 and a camera 210 provided on one surface 252. The electronic device 101 may include the first housing 230, the second housing 240, the hinge assembly 235 which rotatably couples the second housing 240 to the first housing 230. The electronic device 101 may include the display 250. However, it is not limited thereto.

According to an embodiment, the display 250 of the electronic device 101 may output visualized information to a user by being controlled by a controller such as a processor (e.g., a processor 120 of FIG. 1). The display 250 may include a flat panel display (FPD) and/or electronic paper. The FPD may include a liquid crystal display (LCD), a plasma display panel (PDP), and/or one or more light emitting diode (LED). The LED may include an organic light emitting diode (OLED).

For example, the display 250 may include at least one of a cover panel (C-panel, or cover panel) for protecting the display 250, a base substrate, a pixel layer (or an organic light emitting diode layer) including pixels emitting light based on a voltage applied from a thin film transistor (TFT) layer formed on the base substrate, or a polarizing layer provided on the pixel layer. For example, the substrate may be formed of a plurality of layers.

According to an embodiment, the display 250 of the electronic device 101 may include a sensor (e.g., a touch sensor panel (TSP)) for detecting an external object (e.g., a user's finger) on the display 250. For example, based on the TSP, the electronic device 101 may detect an external object that contacts the display 250 or floats on the display 250. In response to detecting the external object, the electronic device 101 may perform a function associated with a specific visual object (e.g., a screen) corresponding to the position of the external object on the display 250 among the visual objects displayed in the display 250.

Referring to FIG. 2B, the electronic device 101 according to an embodiment may include at least one of the processor 120, a memory 130, the camera 210, or a sensor 220. The processor 120, the memory 130, the camera 210, and the sensor 220 may be electronically and/or operably coupled with each other by an electronic component such as a communication bus. For example, the sensor 220 may include at least one of an acceleration sensor 221, a gyro sensor 222, or a hall sensor 223. Although illustrated based on different blocks, embodiments are not limited thereto. For example, some of the hardware components illustrated in FIG. 2B (e.g., the processor 120, the memory 130, the camera 210, and/or the sensor 220) may be included in a single integrated circuit, such as a system on a chip (SoC). The type and/or number of the hardware components included in the electronic device 101 is not limited as illustrated in FIG. 2B. For example, the electronic device 101 may include only some of the hardware components illustrated in FIG. 2B. The processor 120, the memory 130, the camera 210, and/or the sensor 220 may be illustrated in a singular number but may be a plurality.

According to an embodiment, the processor 120 of the electronic device 101 may correspond to at least a portion of the processor 120 of FIG. 1. According to an embodiment, the processor 120 may include the hardware component for processing data based on one or more instructions. The hardware component for processing data may include, for example, an arithmetic and logic unit (ALU), a floating point unit (FPU), a field programmable gate array (FPGA), an application processor (AP), a micro-computer and/or micro-controller (Micom), and/or a central processing unit (CPU). The number of processors 120 may be one or more. For example, the processor 120 may have a structure of a multi-core processor such as a dual core, a quad core, or a hexa core. For example, the processor 120 may have a structure of a single core processor such as a single core.

According to an embodiment, the memory 130 of the electronic device 101 may include the hardware component for storing data and/or instructions input and/or output to the processor 120. For example, the memory 130 may include volatile memory such as random-access memory (RAM) and/or non-volatile memory such as read-only memory (ROM). For example, the volatile memory may include at least one of dynamic RAM (DRAM), static RAM (SRAM), Cache RAM (PSRAM), and pseudo RAM (PSRAM). For example, the non-volatile memory may include at least one of a programmable ROM (PROM), an erasable PROM (EPROM), and an electrically erasable PROM (EEPROM).

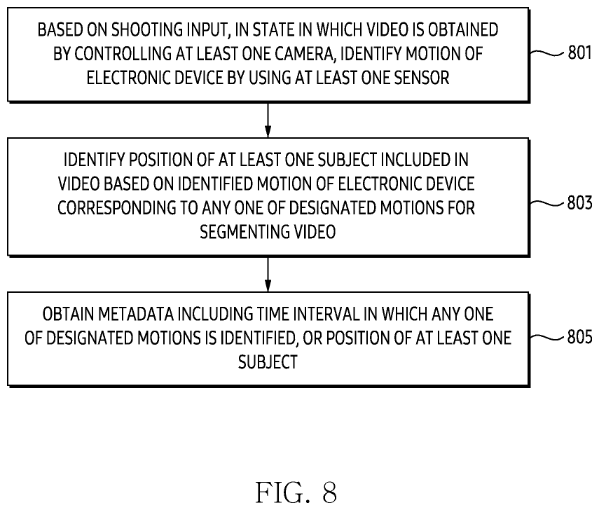

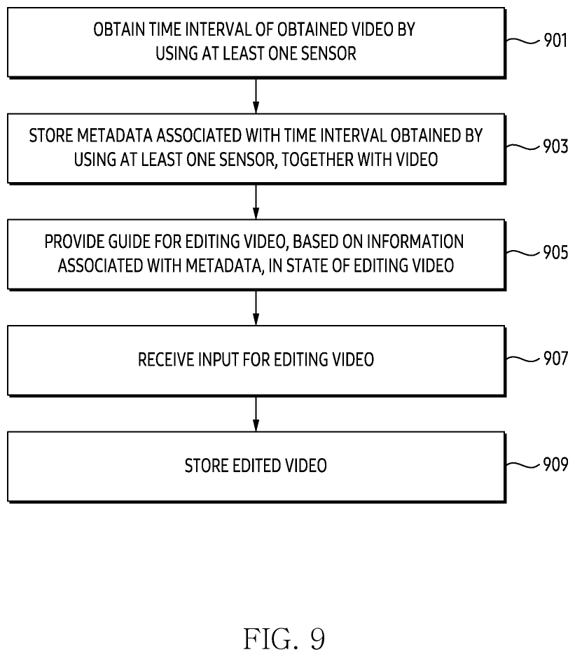

According to an embodiment, in the memory 130 of the electronic device 101, one or more instructions indicating an operation in which the processor 120 performs data may be stored. A set of instructions may be referred to as firmware, operating system, process, routine, sub-routine, and/or application. For example, the electronic device 101 and/or the processor 120 of the electronic device 101 may perform at least one of the operations of FIGS. 8 to 9 by executing a set of a plurality of instructions distributed in the form of the application.

According to an embodiment, the camera 210 of the electronic device 101 may include cameras having different angle of view (or FoV). For example, the electronic device 101 may obtain a video through the camera 210 based on a shooting input. For example, the electronic device 101 may obtain the video by controlling the camera 210. The video may be configured with a plurality of frames. The video may be configured with continuous (or sequential) images obtained through the camera 210.

According to an embodiment, the sensor 220 of the electronic device 101 may detect a state (e.g., a folding state or an unfolding state) of the electronic device 101 or an external environmental state. The electronic device 101 may generate, from the sensor 220, an electrical signal or a data value corresponding to the detected state. For example, the sensor 220 may include at least one acceleration sensor 221, the gyro sensor 222, and/or the hall sensor 223.

For example, the sensor 220 may be for detecting a motion of the electronic device 101. For example, based on the sensor 220, the electronic device 101 may detect an angle between the first housing 230, the hinge assembly 235, and the second housing 240. For example, the electronic device 101 may obtain the angle based on the hall sensor 223. For example, the electronic device 101 may identify the state of the electronic device 101 based on the sensor 220. For example, the electronic device 101 may identify the unfolding state in which a direction 261 of one surface 251-1 of the first housing 230 and a direction 262 of one surface 251-2 of the second housing 240 are parallel. For example, the electronic device may identify the folding state in which the direction 261 of the one surface 251-1 of the first housing 230 and the direction 262 of the one surface 251-2 of the second housing 240 are opposite.

For example, the electronic device 101 may identify a flex mode in which an angle between the one surface of the first housing 230 and the one surface of the second housing 240 is identified within a designated range. For example, while identifying the flex mode, the electronic device 101 may change a user interface (UI) displayed on the screen of the display (e.g., the display 250 of FIG. 2A).

For example, the electronic device 101 may identify the angle between the direction 253 of the one surface 251-1 of the first housing 230 and the direction 254 of the one surface 251-2 of the second housing 240, by using the hall sensor 223. The electronic device 101 may identify the mode and/or the state of the electronic device 101, based on the angles between the one surface 251-1 and the one surface 251-2.

According to an embodiment, the sensor 220 of the electronic device 101 may include the acceleration sensor 221 and/or the gyro sensor 222 for measuring a physical movement of the electronic device 101. For example, the acceleration sensor 221 may output electrical information indicating the magnitude of the gravitational acceleration measured at each of a plurality of designated axes (e.g., an x-axis, a y-axis, and a z-axis) perpendicular to each other. For example, the processor 120 of the electronic device 101 may measure the motion of the electronic device 101 in a physical space based on the electrical information outputted from the acceleration sensor 221. The motion measured by the electronic device 101 may indicate an orientation of the electronic device 101 measured by the acceleration sensor 221 and/or a shape of the electronic device 101. The electronic device 101 may determine the mode of the electronic device 101 based on the measured motion. The electronic device 101 may adjust the size or position of the screen displayed in the display based on the determined mode. For example, the electronic device 101 may measure the electrical information indicating the shape of the electronic device 101 by using another sensor (e.g., the gyro sensor 222 and/or the Hall sensor 223) that is distinct from the acceleration sensor 221. For example, the electronic device 101 may identify a portion where at least one screen is displayed on the display based on the motion of the electronic device 101, by using the acceleration sensor 221.

According to an embodiment, the hall sensor 223 may include one or more magnets and/or one or more magnetic sensors. The one or more magnets and one or more magnetic sensors included in the hall sensor may be provided at different positions in the electronic device 101. A positional relationship of the one or more magnets and/or the one or more magnetic sensors in the electronic device 101 may change according to the shape of the electronic device 101. The electronic device 101 may measure the change in the positional relationship through the one or more magnetic sensors. The change in the positional relationship may cause a change in the magnetic field formed by the one or more magnets. The electronic device 101 may obtain an electrical signal indicating the change in the magnetic field by using the hall sensor 223. For example, the electronic device 101 may distinguish the motion or state (e.g., the folding state, or the unfolding state) of the electronic device 101 by using the electrical signal obtained from the hall sensor 223. For example, the electronic device 101 may receive data indicating the state of the electronic device 101 from the hall sensor 223. For example, the hall sensor 223 may output data indicating the shape of the display. The display may be referred to as a flexible display. For example, the shape of the display may be changed as it is folded or unfolded by a folding axis 237. For example, the hall sensor 223 may output different data indicating the shape of the display. For example, the electronic device 101 may identify angles between the first housing 230 and the second housing 240 of the electronic device 101 based on the different data. The electronic device 101 may display the screen in a portion of the display based on the identified angle.

According to an embodiment, the gyro sensor 222 of the electronic device 101 may obtain an electrical signal associated with the rotational speed of the electronic device 101 (e.g., the angular speed of the electronic device 101 with respect to designated axes). The electronic device 101 may identify the motion of the electronic device 101 based on the electrical signal obtained through the gyro sensor 222. Based on the identified motion, the electronic device 101 may store metadata associated with the motion in the video obtained through the camera 210. Hereinafter, the motion of the electronic device 101 may include a motion associated with the rotational speed. For example, the one motion may be a rotational motion of the electronic device 101. For example, the electronic device 101 may identify the magnitude of the rotational motion. For example, the magnitude of the rotational motion may be identified based on data obtained based on the sensor 220 included in the electronic device 101. For example, the magnitude of the rotational motion may be associated with the magnitude of the angular speed of the electronic device 101 rotating based on an axis formed inside or outside the electronic device 101.

According to an embodiment, the electronic device 101 may obtain the video by controlling the camera 210 based on the shooting input. The electronic device 101 may identify the angles of the first housing 230, the hinge assembly 235, and the second housing 240 by using the sensor 220 in the state of obtaining the video. For example, the sensor 220 may include the hall sensor 223. The electronic device 101 may identify the angle changing by exceeding the designated range. For example, the designated range may be a range capable of detecting a change in the mode and/or the state of the electronic device 101.

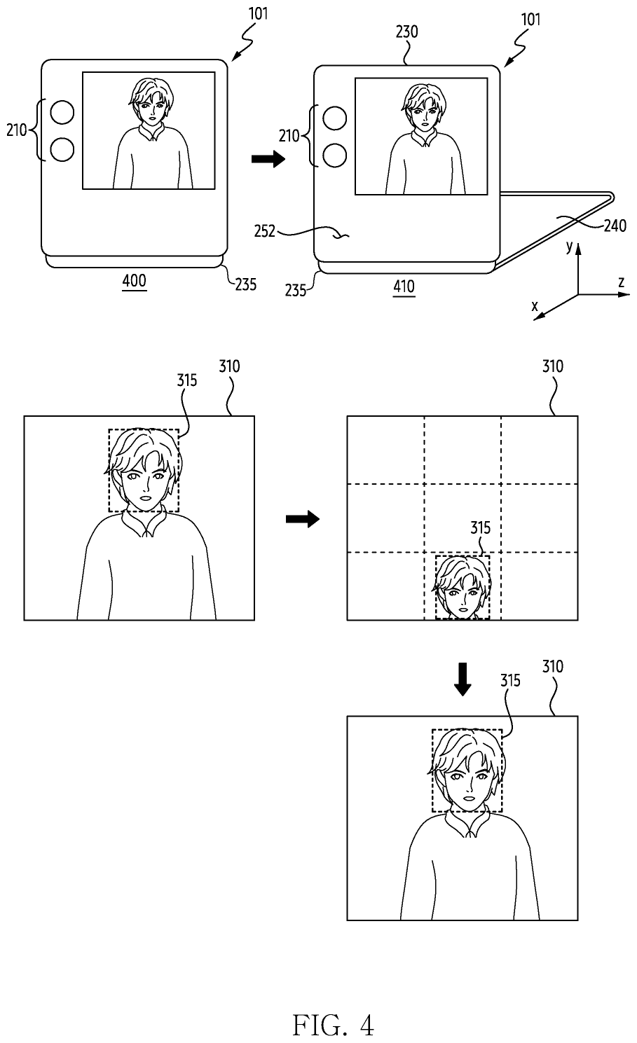

According to an embodiment, the electronic device 101 may identify the motion of the electronic device 101 corresponding to any one of designated motions for segmenting the video. For example, the electronic device 101 may identify at least one subject included in the video, based on the motion, in the state of obtaining the video. For example, the designated motions may be associated with at least one of the mode or the state of the electronic device 101. For example, the designated motions may be associated with at least a portion of the electrical signal obtained by using the sensor 220 of the electronic device 101. For example, the electronic device 101 may store metadata associated with a time interval in which the designated motion is identified in the video, in the state of obtaining the video. The electronic device 101 may store the video including the metadata in the memory 130. A description associated with the designated motions of the electronic device 101 will be described later in FIG. 4.

According to an embodiment, the electronic device 101 may identify at least one of the position or direction of at least one subject in the video in the state of obtaining the video. For example, the electronic device 101 may identify the time interval while at least one of the position or direction of the at least one subject exceeds the designated range. The electronic device 101 may obtain metadata including the time interval. The electronic device 101 may include the metadata in the video. The electronic device 101 may store the video including the metadata in the memory 130.

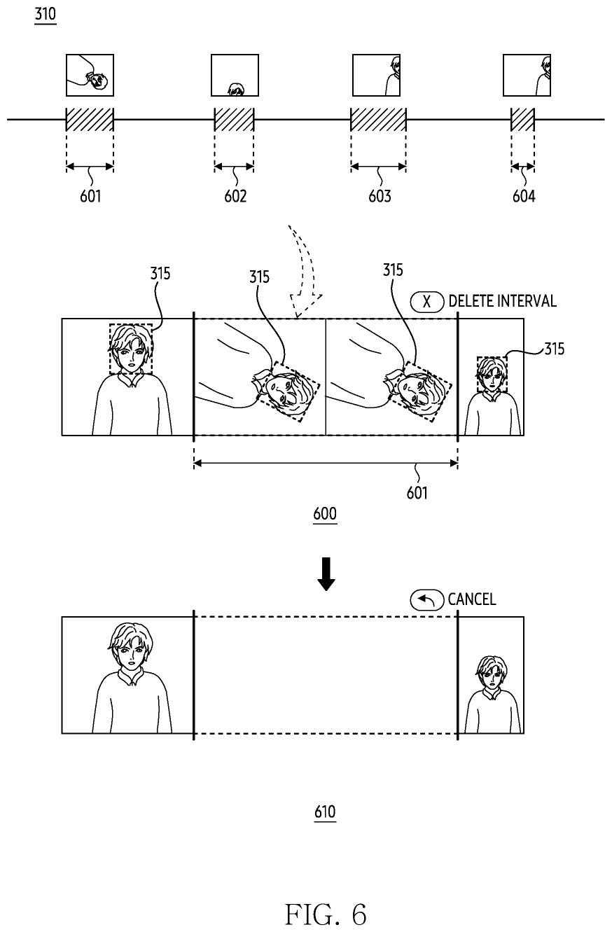

According to an embodiment, the electronic device 101 may edit the video including the metadata. For example, while editing the video including the metadata, the electronic device 101 may provide a visual object associated with the metadata or a guide for editing the video associated with the metadata. The guide for editing the video will be described later in FIG. 6.

According to an embodiment, the electronic device 101 may identify at least one subject in the video based on the identified angles between the first housing 230and the second housing 240, which change by exceeding the designated range. For example, the electronic device 101 may determine that the subject is included in a specific category corresponding to the face based on eyes, a nose, a mouth, and/or an ear that are identified as being included in the subject. For example, the electronic device 101 may identify subjects based on information obtained based on hardware (e.g., neural processing unit (NPU), and/or graphic processing unit (GPU)) for performing a computation associated with artificial intelligence, software for providing a function associated with the artificial intelligence and/or an external electronic device (e.g., a server providing a function associated with the artificial intelligence).

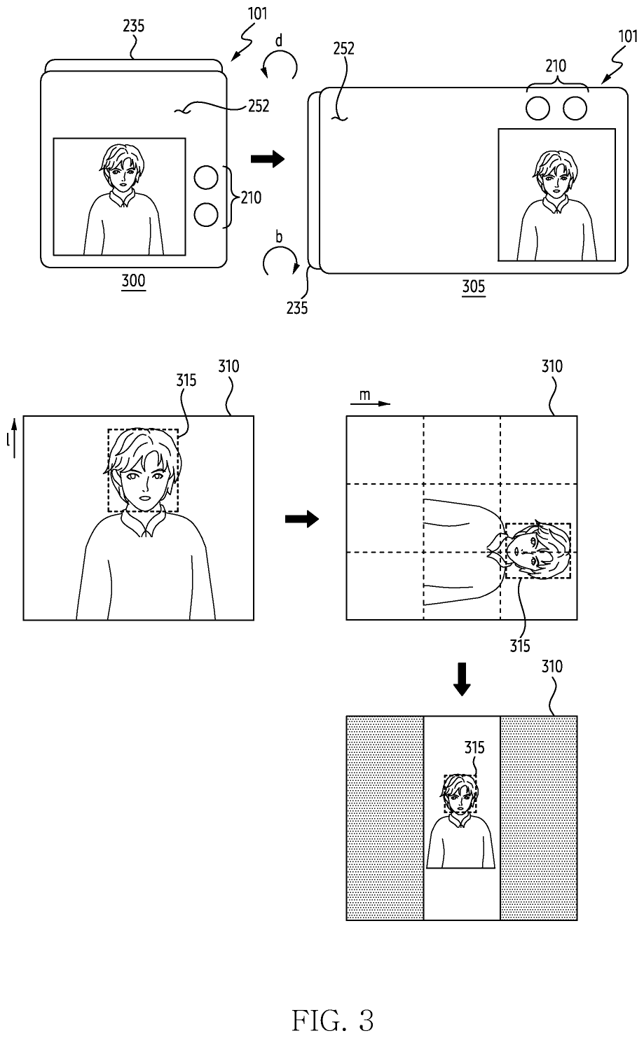

According to an embodiment, the electronic device 101 may identify at least one subject included in a designated portion of the video. For example, the designated portion of the video may include a portion that is spaced apart from a border line or edge of the video by a distance less than a designated distance. The electronic device 101, based on the at least one subject identified as being included in the designated portion, may obtain information indicating the time interval including the timing at which the at least one subject is identified in the designated portion. A description of an operation of the electronic device 101 that obtained the information indicating the time interval including the timing at which the at least one subject is identified in the designated portion will be described later in FIG. 3.

According to an embodiment, the electronic device 101 may identify the motion of the electronic device 101 by using the sensor 220. The motion may include the mode and/or the state of the electronic device 101. The mode of the electronic device 101 may include the flex mode. The state of the electronic device 101 may include the folding state and the unfolding state.

The electronic device 101 may identify the motion based on the electrical signal obtained by using the sensor 220 of the electronic device 101. For example, the motion may be determined according to a direction in which the electronic device 101 faces. For example, the electronic device 101 may obtain the motion of the electronic device 101 based on obtaining at least one of the magnitude or the direction of the acceleration (or force) acting on the electronic device 101 by using the acceleration sensor 221.

For example, the electronic device 101 may obtain the angular speed of the electronic device 101 rotating based on the gyro sensor 222 by using the gyro sensor 222. For example, the electronic device 101 may obtain the angular speed of the electronic device 101, by obtaining the Coriolis force acting on the electronic device 101 by using the gyro sensor 222. The electronic device 101 may identify the motion of the electronic device 101 based on the obtained angular speed.

For example, the electronic device 101 may identify at least one of the state or the mode of the electronic device 101 by using the hall sensor 223. For example, the electronic device 101 may obtain the angle between the first housing 230, the hinge assembly 235, and the second housing 240, by using the hall sensor 223. The electronic device 101 may obtain the folding state in which the angle is in a first designated range. For example, the first designated range may include a range in which the angle between the first housing 230, the hinge assembly 235, and the second housing 240 is greater than or equal to 0° and less than 20°. For example, the electronic device 101 may identify the flex mode in which the angle between the first housing 230, the hinge assembly 235, and the second housing 240 is in a second designated range, by using the hall sensor 223. For example, the second designated range may include a range in which the angle between the first housing 230, the hinge assembly 235, and the second housing 240 is greater than 20° and less than 160°. For example, the electronic device 101 may identify the unfolding state in which the angle between the first housing 230, the hinge assembly 235, and the second housing 240 is in a third designated range. For example, the third designated range may include a range in which the angle between the first housing 230, the hinge assembly 235, and the second housing 240 is greater than or equal to 160° and less than or equal to 180°.

As described above, according to an embodiment, the electronic device 101 may provide a guide associated with the metadata while editing the video, by obtaining the video including the metadata. The electronic device 101 may enhance the user experience of the electronic device 101 by providing the guide.

FIG. 3 illustrates an example of a video obtained by identifying a motion of an electronic device according to an embodiment. An electronic device 101 of FIG. 3 may be an example of the electronic device 101 of FIGS. 1, 2A, and/or 2B. A camera 210 of FIG. 3 may be an example of the camera 210 of FIGS. 2A and/or 2B. Operations of FIG. 3 may be executed by the processor 120 of FIGS. 1 and/or 2B.

Referring to FIG. 3, according to an embodiment, the electronic device 101 may obtain the video through the camera 210. The electronic device 101 may obtain the video by controlling the camera 210 in a folding state, an unfolding state, and/or a flex mode. The electronic device 101 may identify at least one subject 315 while obtaining the video. For example, the electronic device 101 may identify a direction of the at least one subject 315 identified in the video.

According to an embodiment, the electronic device 101 may obtain a video 310 by controlling the camera 210 provided on one surface 252 in state 300. For example, the electronic device 101 may identify the direction of the at least one subject 315 included in the video 310. For example, the direction of the at least one subject 315 identified in the state 300 may be referred to as direction 1.

According to an embodiment, the electronic device 101 may identify the motion of the electronic device 101 based on an acceleration sensor (e.g., an acceleration sensor 221 of FIG. 2B) and/or a gyro sensor (e.g., a gyro sensor 222 of FIG. 2B). For example, the electronic device 101 may identify rotating in a counterclockwise direction d and/or a clockwise direction b through the acceleration sensor and/or the gyro sensor. For example, the electronic device 101 may identify a designated motion of the electronic device 101 based on the acceleration sensor and/or the gyro sensor. The electronic device 101 may obtain a parameter associated with the designated motion. The parameter may be associated with an electrical signal obtained based on a sensor (e.g., a sensor 220 of FIG. 2B) of the electronic device 101. For example, the designated motion may include a state in which the electronic device 101 is rotated, such as state 305. However, it is not limited thereto. For example, while obtaining the video 310 in the state 305, the electronic device 101 may obtain metadata for indicating the obtained time interval in the state 305. The electronic device 101 may include the metadata in the video 310 and may store it in a memory (e.g., a memory 130 of FIGS. 1 and/or 2B).

The electronic device 101 may obtain the video 310 in the state 305. The electronic device 101 may identify the at least one subject 315 included in the video 310. The electronic device 101 may identify the direction of the at least one subject 315 included in the video 310 obtained in the state 305. For example, the direction of the at least one subject 315 may be referred to as an m direction. For example, while identifying the at least one subject 315 pointing in the m direction, the electronic device 101 may identify that at least one of the magnitude or the direction of acceleration (or force) applied to the electronic device 101 is in a designated range through the acceleration sensor. For example, the designated range may be associated with the motion of the electronic device 101. For example, the designated range may be associated with the degree to which the electronic device 101 is inclined. For example, the electronic device 101 may identify the motion of the electronic device 101 based on the acceleration sensor and/or the gyro sensor. For example, the electronic device 101 may obtain information indicating the time interval in which at least one of the magnitude or the direction of the acceleration acting on the electronic device 101 obtained by the acceleration sensor is in the designated range, in the state of obtaining the video 310. The electronic device 101 may include the metadata associated with information indicating the time interval in the video 310.

According to an embodiment, the electronic device 101 may identify the timing when at least one of the magnitude or the direction of the acceleration (or force) acting on the electronic device 101 is identified in the designated range. The electronic device 101 may identify the time interval including the timing. The electronic device 101 may obtain the metadata associated with the time interval including the timing.

According to an embodiment, the electronic device 101 may identify an angle between the at least one subject 315 and a border line of the video 310. The electronic device 101 may identify that the angle between the at least one subject 315 and the border line (or edge) of the video 310 exceeds a designated threshold. For example, the electronic device 101 may obtain the time interval including the timing identified as exceeding the designated threshold, based on being identified that the angle between the at least one subject 315 and the border line of the video 310 has exceeded the designated threshold. The electronic device 101 may store the metadata associated with the time interval in the video 310. For example, the electronic device 101 may obtain information for rotating and displaying the video 310 in the time interval including the timing identified as exceeding the designated threshold. The electronic device 101, in a state for editing the video 310, may display a guide for editing the video 310 on the screen by using the information for rotating and displaying the video 310.

As described above, according to an embodiment, the electronic device 101 may obtain the metadata associated with the time interval including the timing identified as exceeding the designated threshold. The electronic device 101 may enhance the user experience of the electronic device 101 by providing the guide for editing the video 310 by using the metadata.

FIG. 4 illustrates an example of a video obtained by identifying a motion of an electronic device according to an embodiment. An electronic device 101 of FIG. 4 may be an example of the electronic device 101 of FIGS. 1, 2a, 2b, and/or 3. Operations of FIG. 4 may be executed by a processor 120 of FIGS. 1 and/or 2B.

Referring to FIG. 4, according to an embodiment, the electronic device 101 may obtain the video by controlling the camera 210, in a mode and/or a state associated with an angle between a first housing 230 and/or a second housing 240. For example, the mode and/or the state associated with the angle between the first housing 230, a hinge assembly 235, and/or the second housing 240 may include a flex mode, a folding state, and/or an unfolding state. For example, the flex mode may include a case where an angle between the first housing 230, the hinge assembly 235, and the second housing 240 is in a designated range. For example, the flex mode may include a case where the angle between the first housing 230, the hinge assembly 235, and the second housing 240 is greater than 20° and less than 160°. For example, the folding state may include a case where the angle between the first housing 230, the hinge assembly 235, and the second housing 240 is greater than or equal to 0° and less than or equal to 20°. For example, the unfolding state may include a case where an angle between the first housing 230, the hinge assembly 235, and the second housing 240 is greater than or equal to 160° and less than or equal to 180°. According to an embodiment, the electronic device 101 may identify the motion of the electronic device 101 based on the angle between the first housing 230, the hinge assembly 235, and the second housing 240. For example, the electronic device 101 may obtain a parameter associated with the motion. For example, the parameter associated with the motion may be associated with the magnitude and/or the direction of acceleration (or force) applied to the electronic device 101. The parameter associated with the motion may be associated with the angle between the first housing 230, the hinge assembly 235, and the second housing 240 of the electronic device 101. The electronic device 101 may obtain metadata based on the motion of the electronic device 101 in a state of obtaining a video 310.

According to an embodiment, the electronic device 101 may obtain the video 310 in state 400. For example, the state 400 may be referred to as the unfolding state. For example, the electronic device 101 may identify at least one subject 315 while obtaining the video in the state 400. The electronic device 101 may obtain the video 310 while changing from the state 400 to state 410. For example, while changing from the state 400 to the state 410, the electronic device 101 may identify a position of the at least one subject 315 included in the video 310. The electronic device 101 may identify a distance of the at least one subject 315 from a border line (or edge) of the video 310. For example, the electronic device 101 may identify the at least one subject 315 in a designated portion spaced apart from the border line of the video 310 by a distance less than a designated distance. For example, the electronic device 101 may obtain a time interval in which the at least one subject 315 is identified in the designated portion spaced apart by less than the designated distance from the border line. The electronic device 101 may obtain information indicating the time interval. The electronic device 101 may include the metadata including the information indicating the time interval in the video 310 and may store it in a memory. According to an embodiment, the electronic device 101 may provide a guide indicating the time interval in a state of editing the video 310.

As described above, according to an embodiment, the electronic device 101 may identify that the at least one subject 315 is included in the designated portion. The electronic device 101 may obtain the metadata including the time interval during which the at least one subject 315 is identified in the designated portion. The electronic device 101 may obtain the video 310 including the metadata. The electronic device 101 may enhance the user experience of the electronic device 101 by providing a guide associated with the time interval in the state of editing the video 310.

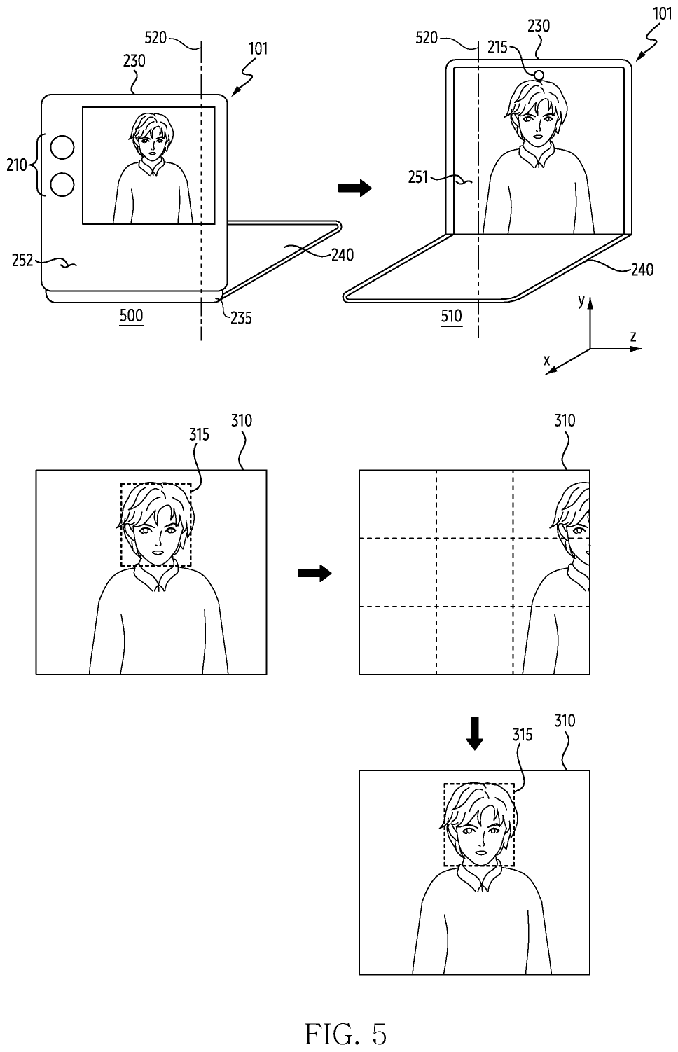

FIG. 5 illustrates an example of a video obtained by identifying a motion of an electronic device according to an embodiment. An electronic device 101 of FIG. 5 may be an example of the electronic device 101 of FIGS. 1, 2A, 2B, 3, and/or 4. A camera 210 of FIG. 5 may be an example of the camera 210 of FIGS. 2A, 2B, 3, and/or 4. A camera 215 of FIG. 5 may be an example of the camera 215 of FIG. 2A. Operations of FIG. 5 may be executed by a processor 120 of FIGS. 1 and/or 2B.

Referring to FIG. 5, according to an embodiment, the electronic device 101 may obtain a video 310 by controlling the camera 210 in a state 500. The electronic device 101 may identify at least one subject 315 while obtaining the video 310 by controlling the camera 210. The electronic device 101 may rotate based on one axis 520 while obtaining the video 310 by controlling the camera 210. A position of the one axis 520 is not limited. The electronic device 101 may obtain the video 310 by controlling the camera 215, in a state 510 in which the rotation is completed. For example, the electronic device 101 may identify a change in an optical axis of the camera 210. The electronic device 101 may identify a change in motion of the electronic device 101, while the optical axis changes. The electronic device 101 may identify getting out of the video 310 after the at least one subject 315 is identified in a designated portion, while the optical axis changes. For example, the at least one subject 315 getting out of the video 310 may include that the at least one subject 315 is not identified in the video 310.

According to one embodiment, the electronic device 101 may identify the motion of the electronic device 101 through at least one sensor (e.g., a sensor 220 of FIG. 2B) while obtaining the video 310 by controlling the camera 210. The motion of the electronic device 101 may be associated with at least one of the magnitude or the direction of acceleration (or force) acting on the electronic device 101. The motion may be associated with a mode and/or a state of the electronic device 101. The mode and/or the state may include a flex mode, a folding state, and/or an unfolding state of the electronic device 101. For example, the motion may include a rotational motion. For example, the rotational motion may include roll, pitch, and/or yaw. For example, the roll may include rotating based on a direction in which an optical axis of the camera faces. For example, in case that the direction in which the optical axis of the camera faces is the x-axis, the pitch may include rotating based on a y-axis perpendicular to the direction in which the optical axis of the camera faces. For example, in case that the direction in which the optical axis of the camera faces is the x-axis, the yaw may include rotating in a direction facing the z-axis. However, it is not limited thereto.

According to an embodiment, the electronic device 101 may obtain a parameter associated with the motion of the electronic device 101. The electronic device 101 may identify changing from the state 500 to the state 510 based on the parameter associated with the motion of the electronic device 101. Based on changing to the state 510, the electronic device 101 may obtain the video 310 by controlling the camera 215 provided on a surface 251 opposite to a surface 252 on which the camera 210 is provided.

According to an embodiment, the electronic device 101 may obtain a time interval including a timing of changing from the state 500 to the state 510, in a state of obtaining the video 310. The electronic device 101 may obtain metadata associated with the time interval including the changed timing. The electronic device 101 may store the video 310 including the metadata in a memory. The electronic device 101 may provide a guide for editing the video 310, in a state of editing the video 310.

As described above, according to an embodiment, while obtaining the video 310, the electronic device 101 may obtain the time interval including the timing of changing from the state 500 to the state 510. The electronic device 101 may obtain the metadata associated with the time interval. The electronic device 101 may store the video 310 including the metadata in the memory. While editing the video 310 including the metadata, the electronic device 101 may display information associated with the time interval on the screen. The electronic device 101 may enhance the user experience of the electronic device 101 by displaying the information associated with the time interval in the state of editing the video 310.

FIG. 6 illustrates an example of a state of use of an electronic device for guiding editing of a video, according to an embodiment. The electronic device of FIG. 6 may be an example of an electronic device 101 of FIGS. 1, 2A, 2B, 3, 4, and/or 5. Operations of FIG. 6 may be executed by a processor 120 of FIGS. 1 and/or 2B.

Referring to FIG. 6, according to an embodiment, the electronic device may provide a state for performing at least one of editing or segmenting a video 310 including time intervals 601, 602, 603, and 604 obtained based on a sensor (e.g., a sensor 220 of FIG. 2B). For example, the state for editing and/or segmenting the video 310 may be referred to as state 600, and/or state 610.

According to an embodiment, the electronic device may obtain information associated with the motion of the electronic device, in a state in which at least one subject 315 is identified. The electronic device may obtain the information associated with the motion of the electronic device based on the sensor. For example, the information associated with the motion of the electronic device may be obtained based on an electrical signal obtained based on the sensor. For example, the electronic device may obtain the information associated with the motion based on the electrical signal obtained from at least one sensor. The electronic device may identify whether the information associated with the motion matches a designated motion. For example, while identifying the at least one subject, the electronic device may identify whether the motion of the electronic device corresponds to the designated motion. The electronic device may identify each of the time intervals 601, 602, 603, and 604, based on the motion of the electronic device identified as being matching the designated motion.

For example, obtaining the video by identifying the motion of the electronic device may refer to Table 1 below. For example, the electronic device may obtain the time intervals 601, 602, 603, and 604 based on the electrical signals obtained the by at least one sensor (e.g., the gyro sensor, the acceleration sensor, and the hall sensor).

TABLE 1

| | Gyro sensor and/or | | |
|---|---|---|---|
| | Acceleration sensor | Hall sensor | Subject Identification |
| first case | Including increase/ | X | ◯ (change in |
| | decrease interval | | direction) |
| second case | Including increase/ | X | ◯ (change in |
| | decrease interval | | direction) |
| third case | Including increase/ | 20° to 80° | ◯ (change in position |
| | decrease interval | | or direction) |
| fourth case | X | 80° to 160° | X |
| fifth case | X | 160° to 180° | X |

Referring to Table 1, according to an embodiment, the electronic device may identify a change in magnitude of an electrical signal obtained through the gyro sensor and/or the acceleration sensor. The electronic device may identify the motion of the electronic device based on the change in the magnitude of the electrical signal obtained through the gyro sensor and/or the acceleration sensor.

In the first case and/or the second case of Table 1, the electronic device may identify the change in the magnitude of the electrical signal obtained based on the gyro sensor and/or the acceleration sensor. For example, the first case and/or the second case may be matched to the time interval 601. For example, while obtaining the video 310 including the at least one subject 315, the electronic device may identify the motion of the electronic device based on the gyro sensor and/or the acceleration sensor. The electronic device may identify that the motion is matched to the designated motion. For example, the designated motion may include that the electronic device rotates by 90° in a counterclockwise direction (e.g., a direction d of FIG. 3). For example, the designated motion may include that the electronic device rotates by 180° in a clockwise direction (e.g., a direction b of FIG. 3). For example, the inclined state may include a state in which the direction of the at least one subject exceeds a designated range, while the electronic device obtains the at least one subject. While identifying the at least one subject, the electronic device may obtain the information indicating the time interval 601 based on the identified designated motion. For example, the electronic device may store the metadata associated with the time interval 601 in the video 310. For example, the electronic device may display a guide for indicating the information indicating the time interval 601. For example, the electronic device may display the guide for indicating the information indicating the time interval 601 on the screen as in the state 600. The electronic device may display a guide for proposing the segment of the time interval 601 on the screen. The electronic device may store the video obtained by segmenting the time interval 601, as in the state 610, based on an input that accepts the segment of the time interval 601. The electronic device may display a visual object for canceling the input that accepts the segment, on the screen. The electronic device may restore the segmented time interval 601, based on an input to the visual object for canceling the input that accepts the segment.

According to an embodiment, the electronic device may obtain the electrical signal based on the gyro sensor and/or the acceleration sensor in the third case. Based on the hall sensor, the electronic device may identify an angle between a first housing (e.g., a first housing 230 of FIG. 2A), a hinge assembly (e.g., a hinge assembly 235 of FIG. 2A), and a second housing (e.g., a second housing 240 of FIG. 2A). For example, the angle identified in the third case may be included in a range of greater than 20° and less than 80°. In the angle, the electronic device may be referred to as the flex mode. The electronic device may identify the at least one subject 315 while obtaining the video 310. The electronic device may identify that identification of the at least one subject 315 is stopped, in the video 310. The electronic device may obtain a time interval including a timing at which the identification of the at least one subject 315 is stopped, based on that the identification of the at least one subject 315 is stopped. For example, the time interval including the timing at which the identification of the at least one subject 315 is stopped may include the time interval 602.

According to an embodiment, the electronic device may identify a change in the electrical signal obtained based on the hall sensor in the fourth case. For example, in the fourth case, the electronic device may identify the angle between the first housing, the hinge assembly, and the second housing. For example, the angle identified in the fourth case may be included in a range of greater than or equal to 80° and less than 160°. For example, in the fourth case, the electronic device may obtain the time interval 603 and/or the time interval 604. The time interval 603 and/or the time interval 604 may include a timing at which identification of the at least one subject 315 is stopped from the identification of at least one subject 315. For example, the electronic device may indicate a guide for segmenting the time interval 603.

According to an embodiment, the electronic device may obtain the electrical signal through the hall sensor in the fifth case. For example, the electronic device may identify the state and/or the mode of the electronic device. For example, in the fifth case, the electronic device may identify that the electronic device changes from the flex mode to the unfolding state. For example, the electronic device may obtain a time interval including a timing changing from the flex mode to the unfolding state. The electronic device may store metadata including the time interval in the video 310.

According to an embodiment, the electronic device may obtain information associated with the time intervals 601, 602, 603, and 604 and may store the obtained information together with the video 310. The electronic device may indicate a visual object for guiding the time intervals 601, 602, 603, and 604 in a state for editing and/or segmenting the video 310. The electronic device may receive an input for the visual object. The electronic device may edit and/or segment at least some of the time intervals 601, 602, 603, and 604 based on receiving the input for the visual object. According to an embodiment, the electronic device may edit and/or segment the at least some of the time intervals 601, 602, 603, and 604, and then may restore the at least some of the time intervals 601, 602, 603, and 604.

According to an embodiment, the electronic device may segment at least a portion of the video 310 corresponding to each of the time intervals 601, 602, 603, and 604 based on obtaining information associated with each of the time intervals 601, 602, 603, and 604. The electronic device may store the segmented video 310 and/or metadata associated with the segment based on segmenting the at least the portion of the video 310.

As described above, according to an embodiment, the electronic device may provide a guide for editing and/or segmenting the time intervals 601, 602, 603, and 604 included in the video 310. The electronic device may enhance the user experience of the electronic device by providing a guide matched to the time intervals 601, 602, 603, and 604.

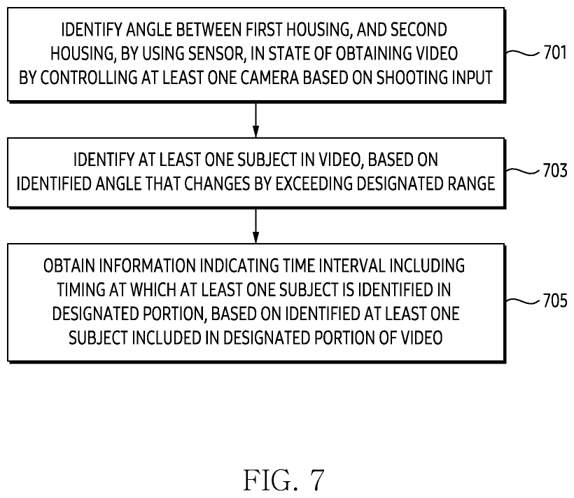

FIG. 7 illustrates an example of a flowchart for an operation of an electronic device, according to an embodiment. The electronic device of FIG. 7 may be an example of an electronic device 101 of FIGS. 1, 2A, 2B, 3, 4, and/or 5 and/or the electronic device of FIG. 6. Operations of FIG. 7 may be executed by a processor 120 of FIGS. 1 and/or 2B.

Referring to FIG. 7, in operation 701, according to an embodiment, the electronic device may receive a shooting input. The electronic device may control at least one camera based on the shooting input. The electronic device may obtain a video (e.g., a video 310 of FIGS. 3 to 6) by controlling the at least one camera. The electronic device may obtain an electrical signal by using a sensor (e.g., a sensor 220 of FIG. 2B) in a state of obtaining the video. By using the sensor, the electronic device may identify an angle between a first housing (e.g., a first housing 230 of FIG. 2A) and a second housing (e.g., a second housing 240 of FIG. 2B). The electronic device may identify a mode and/or a state of the electronic device based on the identified angle. The mode and/or the state of the electronic device may be referred to as a flex mode, an unfolding state, and/or a folding state. According to an embodiment, the electronic device may identify that the angle exceeds a designated range.

In operation 703, according to an embodiment, the electronic device may identify the angle between the first housing and the second housing that change exceeding the designated range. According to an embodiment, the electronic device may obtain information associated with the angle based on that the angle exceeds the designated range. The electronic device may obtain information indicating a time interval including a timing at which the angle exceeds the designated range, based on the identified angle changing by exceeding the designated range. Based on the identified angle, the electronic device may identify at least one subject (e.g., at least one subject 315 of FIG. 3) in the video. For example, the electronic device may identify the at least one subject in the video, based on at least one of the mode and/or the state of the electronic device identified based on the angle. Based on the identified at least one subject, the electronic device may identify a position of the at least one subject in the video. For example, the electronic device may identify that the position of the at least one subject is included in a designated portion.

In operation 705, according to an embodiment, the electronic device may identify the at least one subject included in the designated portion of the video. For example, the electronic device may identify the timing at which the at least one subject is identified in the designated portion of the video, based on the identified at least one subject included in the designated portion of the video. The electronic device may obtain information indicating a time interval including the timing at which the at least one subject is identified in the designated portion. Based on obtaining the information indicating the time interval, the electronic device may store metadata associated with the information in a memory (e.g., a memory 130 of FIGS. 1 and/or 2B) together with the video.

According to an embodiment, the electronic device may identify the motion of the electronic device based on the sensor different from the sensor for identifying the angle in the operation 701. For example, the motion may be associated with the electrical signal obtained based on an acceleration sensor and/or a gyro sensor. For example, the electronic device may obtain at least one of the magnitude or the direction of the acceleration (or force) acting on the electronic device based on the acceleration sensor and/or the gyro sensor. The electronic device may identify the motion of the electronic device based on at least one of the magnitude or the direction of the acceleration (or force) acting on the electronic device. Based on that the motion is identified as a designated motion, the electronic device may obtain metadata indicating a time interval including the timing identified by the designated motion and may store the metadata together with the video.

According to an embodiment, the electronic device may display a visual object for indicating the time interval included in the metadata in a state of editing and/or segmenting the video including the metadata. For example, the visual object may receive an input for segmenting or editing the time interval. The electronic device may perform an operation matching the input based on the input. For example, the electronic device may segment at least a portion of the video based on receiving the input. For example, the electronic device may edit at least the portion of the video based on receiving the input. For example, editing at least the portion of the video may include changing a direction in which the video is displayed.

As described above, according to an embodiment, the electronic device may identify the angle of the first housing, the hinge assembly, and the second housing by using the sensor while obtaining the video. The electronic device may identify the at least one subject based on the identified angle changing by exceeding the designated range. The electronic device may obtain the information indicating the time interval including the timing at which the at least one subject is identified in the designated portion. The electronic device may display a visual object associated with the information indicating the time interval in the editing state of the video. The electronic device may enhance the user experience of the electronic device by displaying the visual object in the editing state.

FIG. 8 illustrates an example of a flowchart for an operation of an electronic device, according to an embodiment. The electronic device of FIG. 8 may be an example of an electronic device 101 of FIGS. 1, 2a, 2b, 3, 4, and/or 5, and the electronic device of FIGS. 6 and/or 7. Operations of FIG. 8 may be executed by a processor 120 of FIGS. 1 and/or 2B.

Referring to FIG. 8, in operation 801, according to an embodiment, the electronic device may receive a shooting input. The electronic device may control at least one camera (e.g., a camera 210 of FIG. 2A) based on the shooting input. The electronic device may obtain a video (e.g., a video 310 of FIGS. 3, 4, 5, and/or 6) by controlling the at least one camera. The electronic device may identify a motion of the electronic device by using at least one sensor (e.g., a sensor 220 of FIG. 2B) in a state of obtaining the video. For example, the electronic device may obtain at least one of magnitude and direction of acceleration (or force) acting on the electronic device by using the at least one sensor. The electronic device may identify the motion of the electronic device based on obtaining at least one of the magnitude and the direction of the acceleration (or force). For example, by using the at least one sensor, the electronic device may identify an angle of a first housing (e.g., a first housing 230 of FIG. 2A), a hinge assembly (e.g., a hinge assembly 235 of FIG. 2A), and a second housing (e.g., a second housing 240 of FIG. 2A). For example, the motion of the electronic device may be associated with a mode and/or a state of the electronic device. For example, the motion of the electronic device may include a flex mode, an unfolding state, and/or a folding state. For example, the electronic device may identify that the motion is a designated motion. The designated motion may be for segmenting the video.

In operation 803, according to an embodiment, the electronic device may identify the designated motion for segmenting the video. For example, the electronic device may identify the motion of the electronic device matching any one of the designated motions. The electronic device may identify a position of at least one subject included in the video based on the identified motion of the electronic device matching any one of the designated motions. For example, the electronic device may identify that the position of the at least one subject is space apart from a border line (or edge) of the video by a distance less than a designated distance. The electronic device may identify the position of the at least one subject or a time interval in which any one of the designated motions is identified.

In operation 805, according to an embodiment, the electronic device may obtain metadata including the time interval in which any one of the designated motions is identified, or the position of the at least one subject. According to an embodiment, the electronic device may identify the direction of the at least one subject. For example, the electronic device may obtain metadata including the direction of the at least one subject based on the identified direction of the at least one subject. The electronic device may obtain metadata including the time interval in which any one of the designated motions is identified, the position of the at least one subject, the direction of the at least one subject, or a combination thereof. The electronic device may store the video including the metadata in a memory (e.g., a memory 130 of FIGS. 1 and/or 2B).

According to an embodiment, the electronic device may display information associated with metadata in a state of editing the video. While displaying the information associated with the metadata, the electronic device may display a visual object for guiding the editing and/or segmenting of the video. The electronic device may receive an input for the visual object. The electronic device may perform an operation matched to the visual object based on receiving the input for the visual object. For example, the operation matched to the visual object may include at least one of segmenting or rotating at least a portion of the video. However, it is not limited thereto.

As described above, according to an embodiment, the electronic device may obtain the metadata including the time interval in which any one of the designated motions is identified, or the position of the at least one subject. The electronic device may provide a guide for editing (or segmenting) the video including the metadata. The electronic device may enhance the user experience of the electronic device by providing the guide.

FIG. 9 illustrates an example of a flowchart for an operation of an electronic device, according to an embodiment. The electronic device of FIG. 9 may be an example of an electronic device 101 of FIGS. 1, 2A, 2B, 3, 4, and/or 5, and the electronic device of FIGS. 6, 7, and/or 8. Operations of FIG. 9 may be executed by a processor 120 of FIGS. 1 and/or 2B.

Referring to FIG. 9, in operation 901, according to an embodiment, the electronic device may obtain a video through a camera (e.g., a camera 210 of FIG. 2A). While obtaining the video, the electronic device may obtain a time interval of the obtained video by using at least one sensor (e.g., a sensor 220 of FIG. 2B). For example, the time interval may be associated with a change in an electrical signal obtained by the at least one sensor. The electronic device may identify a motion of the electronic device based on the change in the electrical signal obtained by the at least one sensor. For example, the electronic device may identify whether the motion of the electronic device is a designated motion. For example, the designated motion may be associated with magnitude or direction of acceleration (or force) acting on the electronic device. For example, the designated motion may be associated with at least one of a mode or a state of the electronic device. For example, the mode of the electronic device may include a flex mode. For example, the state of the electronic device may include an unfolding state or a folding state.

According to an embodiment, the electronic device may obtain the time interval in which the designated motion is identified by using the at least one sensor. The electronic device may identify at least one subject (e.g., at least one subject 315 in FIG. 3) in the time interval in which the designated motion is identified. The electronic device may identify a position, a direction, or a combination thereof of the at least one subject. The electronic device may obtain metadata associated with the position, the direction, or the combination thereof of the at least one subject.

In operation 903, according to an embodiment, the electronic device may obtain metadata associated with the obtained time interval by using the at least one sensor. The electronic device may obtain metadata associated with the position, the direction, or the combination thereof of the at least one subject. The electronic device may obtain a video including the metadata. The electronic device may store the video including the metadata in a memory (e.g., a memory 130 of FIGS. 1 and/or 2B).

In operation 905, according to an embodiment, the electronic device may edit (or segment) the video including the metadata. For example, the electronic device may indicate information associated with the metadata in a state of editing the video. For example, the information associated with the metadata may be associated with the position, the direction, or the combination thereof of the at least one subject included in the video. For example, the information associated with the metadata may be associated with the change in the electrical signal obtained based on the at least one sensor. For example, the information associated with the metadata may include the time interval.

According to an embodiment, the electronic device may provide a guide for editing (or segmenting) the video based on the information associated with the metadata. For example, the electronic device may provide the guide for editing (or segmenting) the video in the time interval in the state of editing the video. For example, the time interval may include a timing at which the position of the at least one subject is identified as being less than a designated distance from a border line of the video. For example, the time interval may include a timing at which a direction of the at least one subject is identified as exceeding a designated range. For example, the time interval may include a timing at which an electrical signal obtained based on the at least one sensor of the electronic device changes exceeding the designated range.

In operation 907, according to an embodiment, the electronic device may provide the guide for the edit (or segment) of the video. The electronic device may display a visual object for the edit (or segment) of the video in a state in which the guide for the edit of the video is provided. The edit of the video may include rotating the direction of the video. The edit of the video may include segmenting a portion matching the time interval included in the metadata.

According to an embodiment, the electronic device may receive an input for the visual object for the edit of the video. For example, the electronic device may perform an operation matched to the visual object based on the input for the visual object for the edit. The electronic device may receive an input for a visual object for completion of the edit, which is different from the visual object for the edit of the video. The electronic device may complete (or end) the edit of the video based on receiving the input for the visual object for the completion of the edit.

In operation 909, according to an embodiment, the electronic device may store the edited video, for example, after completing the edit of the video. For example, the electronic device may store a video in which a time interval associated with the metadata of the video is edited (or segmented), in the memory.

As described above, according to an embodiment, the electronic device may identify whether the motion of the electronic device matches the designated motion, by using the at least one sensor. The electronic device may identify a time interval in which the motion of the electronic device matches the designated motion. The electronic device may obtain metadata including the time interval. The electronic device may obtain the video including the metadata. The electronic device may edit the video based on obtaining the video. The electronic device may provide the guide for the edit of the video, based on information associated with the metadata, in a state of editing the video. The electronic device may enhance the user experience of the electronic device by providing the guide for the edit of the video.

As described above, according to an embodiment, an electronic device (e.g., an electronic device 101 of FIGS. 1, 2a, 2b, 3, 4, and/or 5) may comprise a first housing (e.g., a first housing 230 of FIGS. 2A and/or 2B), a second housing (e.g., a second housing 240 of FIGS. 2A and/or 2B), a hinge assembly (e.g., a hinge assembly 235 of FIGS. 2A and/or 2B) which rotatably couples the second housing 240 to the first housing 230, a sensor (e.g., a sensor 220 of FIG. 2B, and/or a hall sensor 223 of FIG. 2B) for identifying an angle of the first housing 230, the hinge assembly, and the second housing, a second sensor, at least one camera (e.g., a camera 210 of FIGS. 2A and/or 2B) provided on a surface (e.g., a surface 252 of FIGS. 2A, and/or 2B) of the first housing 230, and a processor (e.g., a processor 120 of FIGS. 1 and/or 2B)). The processor may identify the angle by using the sensor, in state of obtaining a video (e.g., a video 310 of FIGS. 3, 4, 5, and/or 6) by controlling the at least one camera, based on a shooting input. The processor may identify magnitude of a rotational motion of the electronic device, by using the second sensor, in the state of obtaining the video. The processor may obtain information for segmenting a portion corresponding to the time interval in the video, based on the identified time interval (e.g., time intervals 601, 602, 603, and 604 of FIG. 6) in which at least one of the angle changing by exceeding a designated range or the rotational motion exceeding designated magnitude is identified.

According to an embodiment, the processor may obtain the information indicating the time interval, based on the identified at least one subject in the designated portion that is spaced apart from a border line of the video by a distance less than a designated distance.

According to an embodiment, the electronic device may include a second sensor (e.g., a sensor 220 of FIG. 2B, an acceleration sensor 221 of FIG. 2B, and/or a gyro sensor 222 of FIG. 2B) different from the sensor that is the first sensor. The processor may obtain the time interval based on the identified rotation motion of the electronic device through the second sensor.

According to an embodiment, the processor may obtain the time interval including a timing at which the acceleration applied to the electronic device is identified in the designated range, obtained based on the second sensor.

According to an embodiment, the processor may display a guide for indicating the information indicating the time interval, while displaying a screen associated with editing of the video, in the screen.

According to an embodiment, the processor may obtain the time interval including the timing identified as exceeding a designated threshold, based on being identified that an angle between the at least one subject and the border line of the video exceeds a designated threshold.

According to an embodiment, the processor may obtain information for displaying the video by rotating, in the time interval including the timing identified as exceeding the designated threshold.

According to an embodiment, the electronic device may comprise a memory (e.g., a memory 130 of FIGS. 1 and/or 2B). The processor may store the video including metadata associated with the information, in the memory.

According to an embodiment, the electronic device may further comprise a second camera (e.g., a camera 215 of FIGS. 2A and/or 2B) provided on a second surface (e.g., a surface 252 of FIGS. 2A, and/or 2B) opposite to the first surface, which is a first surface, different from the at least one camera which is a first camera, and a second sensor different from the sensor that is the first sensor. The processor may obtain the video by controlling the second camera, based on a parameter associated with the rotational motion of the electronic device through the second sensor, and identifying the at least one subject in a designated portion in a state of obtaining the video by controlling the first camera.

As described above, according to an embodiment, a method of electronic device (e.g., the electronic device 101 of FIGS. 1, 2A, 2B, 3, 4, and/or 5) may comprise identifying an angle by using a sensor (e.g., the sensor 220 of FIG. 2B including the hall sensor 223) for identifying the angle between a first housing 230 and the second housing 240, in a state of obtaining a video by controlling at least one camera (e.g., the camera 210 of FIGS. 2A and/or 2B)provided on a surface (e.g., the surface 252 of FIG. 2A) of the first housing (e.g., the first housing 230 of FIGS. 2A and/or 2B) of the electronic device, based on a shooting input. The method of electronic device may comprise identifying magnitude of a rotational motion of the electronic device, by using the second sensor, in the state of obtaining the video. The method of electronic device may comprise obtaining information for segmenting a portion corresponding to a time interval in the video, based on the identified time interval (e.g., time intervals 601, 602, 603, and 604 of FIG. 6) in which at least one of the angle changing by exceeding a designated range or the magnitude of the rotational motion exceeding designated magnitude is identified.

According to an embodiment, the method of the electronic device may comprise obtaining the information indicating the time interval, based on the identified at least one subject in a designated portion that is spaced apart from a border line of the video by a distance less than a designated distance.

According to an embodiment, the method of the electronic device may comprise obtaining the time interval, based on the identified rotational motion of the electronic device, through the second sensor (e.g., the sensor 220 of FIG. 2B, the acceleration sensor 221 of FIG. 2B, and/or the gyro sensor 222 of FIG. 2B) different from the first sensor.

According to an embodiment, the method of the electronic device may comprise obtaining the time interval including a timing at which the acceleration applied to the electronic device is identified in the designated range, obtained based on the second sensor.

According to an embodiment, the method of the electronic device may comprise displaying a guide for indicating the information indicating the time interval, while displaying a screen associated with editing the video, in the screen.

According to an embodiment, the method of the electronic device may comprise obtaining the time interval including the timing identified as exceeding the designated threshold, based on being identified that an angle between the at least one subject and the border line of the video exceeds a designated threshold.

According to an embodiment, the method of the electronic device may comprise obtaining information for displaying the video by rotating, in the time interval including the timing identified as exceeding the designated threshold.

According to an embodiment, the method of the electronic device may comprise storing the video including metadata associated with the information, in a memory (e.g., a memory 130 of FIGS. 1 and/or 2B).

According to an embodiment, the method of the electronic device may comprise obtaining the video by controlling a second camera provided on a second surface opposite to the one surface that is the first surface on which the first camera is provided, based on a parameter associated with the motion of the electronic device through the second sensor different from the sensor that is the first sensor, and identifying the at least one subject in the designated portion, in a state of obtaining the video by controlling the at least one camera that is the first camera.

As described above, according to an embodiment, the electronic device (e.g., the electronic device 101 of FIGS. 1, 2A, 2B, 3, 4, and/or 5) may comprise at least one sensor (e.g., the sensor 220, the acceleration sensor 221, the gyro sensor 222, and/or the hall sensor 223 of FIG. 2B) for identifying motion of the electronic device, at least one camera (e.g., the camera 210 of FIGS. 2A, and/or 2B), and a processor (e.g., the processor 120 of FIGS. 1 and/or 2B). The processor may identify the motion of the electronic device by using the at least one sensor, in a state of obtaining a video (e.g., the video 310 of FIGS. 3, 4, 5, and/or 6) by controlling the at least one camera, based on a shooing input. The processor may identify position of at least one subject (e.g., at least one subject 315 of FIGS. 3, 4, 5, and/or 6) included in the video, based on the identified motion of the electronic device corresponding to one of designated motions for segmenting the video. The processor may obtain metadata including a time interval in which one of the designated motions is identified, or the position of the at least one subject.

According to an embodiment, the processor may identify that a direction of the at least one subject included in the video exceeds a designated range. The processor may obtain metadata including the direction of the at least one subject, based on a determination that the direction of the at least one subject exceeds the designated range.

According to an embodiment, the processor may identify the motion of the electronic device by obtaining acceleration applied to the electronic device through the at least one sensor.

According to an embodiment, the processor may identify the motion of the electronic device by obtaining the angle between the first housing and the second housing.

According to an embodiment, the electronic device may comprise a memory. The processor may store the metadata together with the video.

According to an embodiment, the processor may obtain the metadata including the position of the at least one subject based on that the position of the at least one subject is less than a designated distance from the border line of the video.

According to an embodiment, the processor may provide at least one guide of the time interval corresponding to the metadata or the position of the at least one subject, in a state of editing the video.

As described above, according to an embodiment, a method of electronic device (e.g., the electronic device 101 of FIGS. 1, 2A, 2B, 3, 4, and/or 5) may comprise identifying the motion of the electronic device by using at least one sensor (e.g., the sensor 220 of FIG. 2B) for identifying the motion of the electronic device in a state of obtaining a video (e.g., the video 310 of FIGS. 3, 4, 5, and/or 6) by controlling at least one camera (e.g., the camera 210 of FIG. 2A), based on the shooting input. The method of the electronic device may comprise identifying position of at least one subject included in the video, based on the identified motion of the electronic device corresponding to one of designated motions for segmenting the video. The method of the electronic device may comprise obtaining metadata including a time interval in which one of the designated motions is identified, or the position of the at least one subject.

According to an embodiment, the method of the electronic device may comprise identifying that the direction of the at least one subject included in the video is a direction exceeding a designated range. The method of the electronic device may comprise obtaining metadata including the direction of the at least one subject based on a determination that the direction of the at least one subject exceeds the designated range.

According to an embodiment, the method of the electronic device may comprise identifying the motion of the electronic device by obtaining acceleration applied to the electronic device through the at least one sensor.

According to an embodiment, the method of the electronic device may comprise identifying the motion of the electronic device by obtaining the angle between the first housing and the second housing.

According to an embodiment, the method of the electronic device may comprise storing the metadata together with the video.

According to an embodiment, the method of the electronic device may comprise obtaining the metadata including the position of the at least one subject based on that the position of the at least one subject is less than a designated distance from the border line of the video.

According to an embodiment, the method of the electronic device may comprise providing at least one guide of the time interval corresponding to the metadata or the position of the at least one subject, in a state of editing the video.

The electronic device according to one or more embodiments disclosed in the present document may be various types of devices. The electronic device may include, for example, a portable communication device (e.g., a smartphone), a computer device, a portable multimedia device, a portable medical device, a camera, a wearable device, or a home appliance. The electronic device according to an embodiment of the present document is not limited to the above-described devices.

The one or more embodiments and terms used herein are not intended to limit the technical features described herein to specific embodiments and should be understood to include various modifications, equivalents, or substitutes of the embodiment. With respect to the description of the drawings, similar reference numerals may be used for similar or related components. The singular form of the noun corresponding to the item may include one or more of the items unless clearly indicated differently in a related context. In this document, each of the phrases such as “A or B”, “at least one of A and B”, “at least one of A, B and C”, “at least one of A, B, or C”, and “at least one of A, B, or C” may include any one of the phrases together, or all possible combinations thereof. Terms such as “first”, “second”, or “second”, or “second” may be used simply to distinguish a corresponding component from another corresponding component, and are not limited to other aspects (e.g., importance or order). When some (e.g., the first) component is referred to as “coupled” or “connected” in another (e.g., the second) component, with or without the term “functional” or “communicatively”, it means that some of the components can be connected directly (e.g., wired), wirelessly, or through a third component.

The term “module” used in one or more embodiments of the present document may include a unit implemented in hardware, software, or firmware and be used interchangeably with terms such as logic, logic block, component, or circuitry, for example. The module may be a minimum unit or a part of the integrally configured component or the component that performs one or more functions. For example, according to an embodiment, the module may be implemented in the form of an application-specific integrated circuit (ASIC).

One or more embodiments of the present document may be implemented as software (e.g., a program) including one or more instructions stored in a storage medium (or external memory) readable by a device (e.g., electronic device 101). For example, a processor (e.g., a processor) of a device (e.g., electronic device 101) may call and execute at least one of the one or more instructions stored from a storage medium. This makes it possible for the device to operate to perform at least one function according to at least one command called. The one or more instructions may include code generated by a compiler or code that may be executed by an interpreter. The device-readable storage medium may be provided in the form of a non-transitory storage medium. Here, the term ‘non-transitory’ only means that a storage medium is a device that is tangible and does not include a signal (e.g., electromagnetic wave), and the term does not distinguish between a case where data is semi-permanently stored and a case where it is temporarily stored.

According to an embodiment, a method according to one or more embodiments disclosed in the present document may be provided by being included in a computer program product. The computer program products may be traded between sellers and buyers as products. The computer program products may be distributed in the form of device-readable storage media (e.g., compact disc read only memory (CD-ROM), or distributed (e.g., downloaded or uploaded) directly or online through an application store (e.g., Play Store™) or between two user devices (e.g., smartphones). In the case of online distribution, at least some of the computer program products may be temporarily stored or temporarily created on a device-readable storage medium such as a manufacturer's server, a server in an application store, or a memory in a relay server.

According to one or more embodiments, each of the above-described components (e.g., a module or a program) may include a single object or a plurality of objects, and some of the plurality of objects may be separated and provided in other components. According to one or more embodiments, one or more components or operations of the above-described corresponding components may be omitted, or one or more other components or operations may be added. Alternatively, or additionally, a plurality of components (e.g., modules or programs) may be integrated into one component. In this case, the integrated component may perform one or more functions of each of the components in the same or similar manner as those performed by the corresponding component among the plurality of components before the integration. According to one or more embodiments, operations performed by a module, a program, or other components may be executed sequentially, in parallel, repeatedly, or heuristic, performed in a different order, omitted, or one or more other operations may be added.

What is claimed is:

1. An electronic device comprising:
a first housing;
a second housing;
a first sensor;
a second sensor;
at least one camera provided on the first housing; and
a processor configured to:
identify an angle between the first housing and the second housing, in a state of obtaining a video by controlling the at least one camera;
identify a magnitude of a rotational motion of the electronic device, in the state of obtaining the video; and
obtain information for segmenting a portion of the video, which corresponds to a time interval in which at least one of the identified angle being changing by exceeding a designated range or the identified magnitude of the rotational motion being exceeding a designated magnitude.

2. The electronic device of claim 1, wherein the processor is further configured to:
identify at least one subject in the video; and
obtain the information, based on the identified at least one subject in a designated portion being spaced apart from a border line of the video by a distance that is less than a designated distance.

3. The electronic device of claim 2, wherein the processor is further configured to obtain the time interval, based on the identified rotational motion of the electronic device, by using the second sensor.

4. The electronic device of claim 3, wherein the processor is further configured to obtain the time interval comprising a timing at which an acceleration applied to the electronic device is identified in the designated range, based on the second sensor.

5. The electronic device of claim 4, further comprising a screen associated with editing of the video,
wherein the processor is further configured to display, on the screen, a guide for indicating the information and the time interval.

6. The electronic device of claim 5, wherein the processor is further configured to obtain the time interval comprising the timing identified as exceeding a designated threshold, based on an angle between the at least one subject and the border line of the video exceeds a designated threshold.

7. The electronic device of claim 6, wherein the processor is further configured to obtain information for displaying the video by rotating, in the time interval.

8. The electronic device of claim 7, further comprising a memory,
wherein the processor is further configured to store, in the memory, the video including metadata associated with the information.

9. The electronic device of claim 8, further comprising a second camera provided on the first housing,
wherein the processor is further configured to obtain the video by controlling the second camera, based on a parameter associated with the rotational motion of the electronic device and based on the identified at least one subject in the designated portion, in a state of obtaining the video by controlling the first camera.

10. A method performed by an electronic device comprising:
identifying an angle between a first housing and a second housing, in a state of obtaining a video by controlling at least one camera provided on the first housing of the electronic device;
identifying a magnitude of a rotational motion of the electronic device, in the state of obtaining the video; and
obtaining information for segmenting a portion corresponding to a time interval of the video, in which at least one of the angle being changing by exceeding a designated range or the identified magnitude of the rotational motion being exceeding a designated magnitude.

11. The method of claim 10, further comprising:
identifying at least one subject in the video; and
obtaining the information indicating the time interval, based on the identified at least one subject in a designated portion that is spaced apart from a border line of the video by a distance less than a designated distance.

12. The method of claim 11, further comprising obtaining the time interval, based on the identified rotational motion of the electronic device, by using the second sensor.

13. The method of claim 12, further comprising obtaining the time interval comprising a timing at which an acceleration applied to the electronic device is identified in the designated range.

14. The method of claim 13, further comprising displaying, on a screen, a guide for indicating the information and the time interval, wherein the screen is associated with editing of the video.

15. The method of claim 14, further comprising obtaining the time interval comprising the timing identified as exceeding a designated threshold, based on an angle between the at least one subject and the border line of the video, which exceeds a designated threshold.

16. The method of claim 15, further comprising obtaining information for displaying the video by rotating, in the time interval comprising the timing identified as exceeding the designated threshold.

17. The method of claim 16, further comprising storing, in a memory, the video comprising metadata associated with the information.

18. The method of claim 17, further comprising obtaining the video by controlling a second camera, based on a parameter associated with the rotational motion of the electronic device through the second sensor and based on the identified at least one subject in the designated portion, in a state of obtaining the video by controlling the first camera.

19. An electronic device comprising:
at least one sensor configured to identify a motion of the electronic device;
at least one camera; and
a processor configured to:
identify, by using the at least one sensor, the motion of the electronic device, in a state of obtaining a video by controlling the at least one camera, based on a shooting input;
identify a position of at least one subject of the video, based on the identified motion of the electronic device, which corresponds to one of designated motions for segmenting the video; and
obtain first metadata comprising a time interval in which one of the designated motions is identified or the position of the at least one subject.

20. The electronic device of claim 19, wherein the processor is further configured to:
identify that a direction of the at least one subject of the video is outside a designated range; and
obtain second metadata comprising the direction of the at least one subject, based on identifying that the direction of the at least one subject exceeds the designated range.
